(19) United States
(12) Patent Application Publication
(10) Pub. No.: US 2015/0067273 A1
(43) Pub. Date: Mar. 5, 2015

(54) COMPUTATION HARDWARE WITH HIGH-BANDWIDTH MEMORY INTERFACE

(71) Applicant: Microsoft Corporation, Redmond, WA (US)

(72) Inventors: Karin Strauss, Seattle, WA (US); Jeremy Fowers, Gainesville, FL (US)

(73) Assignee: Microsoft Corporation, Redmond, WA (US)

(21) Appl. No.: 14/015,872

(22) Filed: Aug. 30, 2013

(51) Int. Cl. G06F 3/06

(52) U.S. Cl. CPC G06F 3/0604; G06F 3/0655; G06F 3/0683
USPC 711/147

(57) ABSTRACT

Various embodiments relating to performing multiple computations are provided. In one embodiment, a computing system includes an off-chip storage device configured to store a plurality of stream elements and associated tags and a computation device. The computation device includes an on-chip storage device configured to store a plurality of independently addressable resident elements, and a plurality of parallel processing units. Each parallel processing unit may be configured to receive one or more stream elements and associated tags from the off-chip storage device and select one or more resident elements from a subset of resident elements driven in parallel from the on-chip storage device. A selected resident element may be indicated by an associated tag as matching a stream element. Each parallel processing unit may be configured to perform one or more computations using the one or more stream elements and the one or more selected resident elements.

### BACKGROUND

Some computing systems include hardware dedicated to performing specific computations in a very fast manner in order to increase overall processing speed and efficiency of the computing system. For example, a computation device may be employed in a computing system to accelerate training and evaluation of deep neural network models (e.g., machine learning). Such machine learning may be applicable to image recognition, speech recognition, factoring large numbers, webpage ranking, and natural language processing and text search, among other applications. In one example, a computation device may be implemented in hardware as a customized integrated circuit (or ‘chip’), such as a field programmable gate array (FPGA). More particularly, in some applications, a computation device may be configured to continuously access data streams stored in the off-chip storage device that may be physically distinct from the computation device to perform such computations. In order to operate in an efficient manner, an available bandwidth between the off-chip storage device and the computation device may be fully utilized to stream data. Furthermore, stream elements from the off-chip storage device may be matched with resident elements from the on-chip storage device in parallel processing units to perform multiple computations in parallel.

In one example approach, to ensure that any resident element may be available to be matched with a stream element for a given computation, all of the resident elements may be replicated multiple times in the on-chip storage device. For example, the computation device may include, for each parallel processing unit, a buffer to store an instance of all of the resident elements. Such an approach may be suitable for low bandwidth interfaces. However, as bandwidth capabilities increase, simply scaling this approach may constrain operation of the computation device by consuming resources of the computation device that could otherwise be utilized in other portions of application logic.

### SUMMARY

Various embodiments relating to performing multiple computations are provided. In one embodiment, a computing system includes an off-chip storage device configured to store a plurality of stream elements and associated tags and a computation device in communication with the off-chip storage device. The computation device includes an on-chip storage device configured to store a plurality of independently addressable resident elements, and a plurality of parallel processing units. Each parallel processing unit may be configured to receive one or more stream elements and associated tags from the off-chip storage device and select one or more resident elements from a subset of resident elements driven in parallel from the on-chip storage device. A selected resident element may be indicated by an associated tag as matching a stream element. Each parallel processing unit may be configured to perform one or more computations using the one or more stream elements and the one or more resident elements selected from the subset.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system according to an embodiment of the present disclosure.

FIG. 2 schematically shows a computation device of the computing system of FIG. 1.

FIG. 3 schematically shows a stream processing unit of the computation device of FIG. 2.

FIG. 4 schematically shows a resident element selector array unit according of the stream processing unit of FIG. 3.

FIG. 5 shows a method for performing computations with a plurality of parallel processing units of a computation device according to an embodiment of the present disclosure.

### DETAILED DESCRIPTION

The present description relates to a hardware device dedicated to performing one or more specific computations in a computing system. The computation device may have a high-bandwidth communications interface with the off-chip storage device to stream data elements. The computation device may be configured to match these stream elements from the off-chip storage device with appropriate resident elements selected from the on-chip storage device to perform multiple computations in parallel. For example, the computation device may be continuously invoked to perform computations as part of a process for training and evaluating deep neural networks (e.g., machine learning).

More particularly, the on-chip storage device may include a resident element data buffer that stores all of the resident elements. The resident element data buffer may be banked so that multiple resident elements may be addressed independently. In other words, the resident element data buffer may enable each resident element or a subset of resident elements to be independently selectable by a different parallel processing unit performing a different computation in the same clock cycle. Furthermore, the computation device may include logic to select, among all the resident elements stored in the resident element data buffer, appropriate resident elements that match stream elements for computations processed in parallel. For example, the appropriate resident elements may be selected based on tags associated with stream elements. In particular, each parallel processing unit may include a resident element selector array, and each selector unit in the array may request a resident element. The requests from all of the selector units in all of the parallel processing units may be aggregated by a priority selector that may form a subset of these requested elements. The subset may account for overlapping requests for the same resident element by different selector units. The subset of resident elements may be driven out of the resident element data buffer. Since some or all of the resident elements of the subset have been requested by more than one selector unit, those resident elements may be opportunistically picked up by multiple parallel processing units as they are driven out and broadcast (or multicast) to all of the parallel processing units. In other words, multiple requests may be fulfilled by a single resident element or a single set of resident elements driven from the resident element data buffer. Furthermore, to avoid competition for a particular resident element by multiple parallel processing units in the same clock cycle, the computation device may be configured to opportunistically pre-fetch resident elements from the resident element data buffer and cache them in advance of a contested clock cycle.

By employing a buffer having independently addressable resident elements and logic to opportunistically select appropriate resident elements for distinct computations, selected resident elements may be made available for parallel processing without having to replicate all resident elements for each parallel processing unit.

Accordingly, the computation device may process multiple computations in parallel while reducing usage of the on-chip resources relative to an approach that replicates all resident elements for each parallel processing unit in the on-chip storage device. Such a configuration may increase efficiency of operation to fully leverage the high-bandwidth communication capability between the computation device and the off-chip storage device. Moreover, the increase in efficiency may allow for the computation device to be employed in high performing uses of sparse matrix multiplication or other sparse matrix operations, for example, those performed in real-time machine learning applications where the computation device may be continuously invoked to quickly perform computations. Such machine learning may be applicable to image recognition, speech recognition, webpage ranking, and natural language processing and text search. In one example, the computation device may be utilized for training and evaluating deep neural networks. In another example, the computation device may be utilized in factoring large numbers, among other applications.

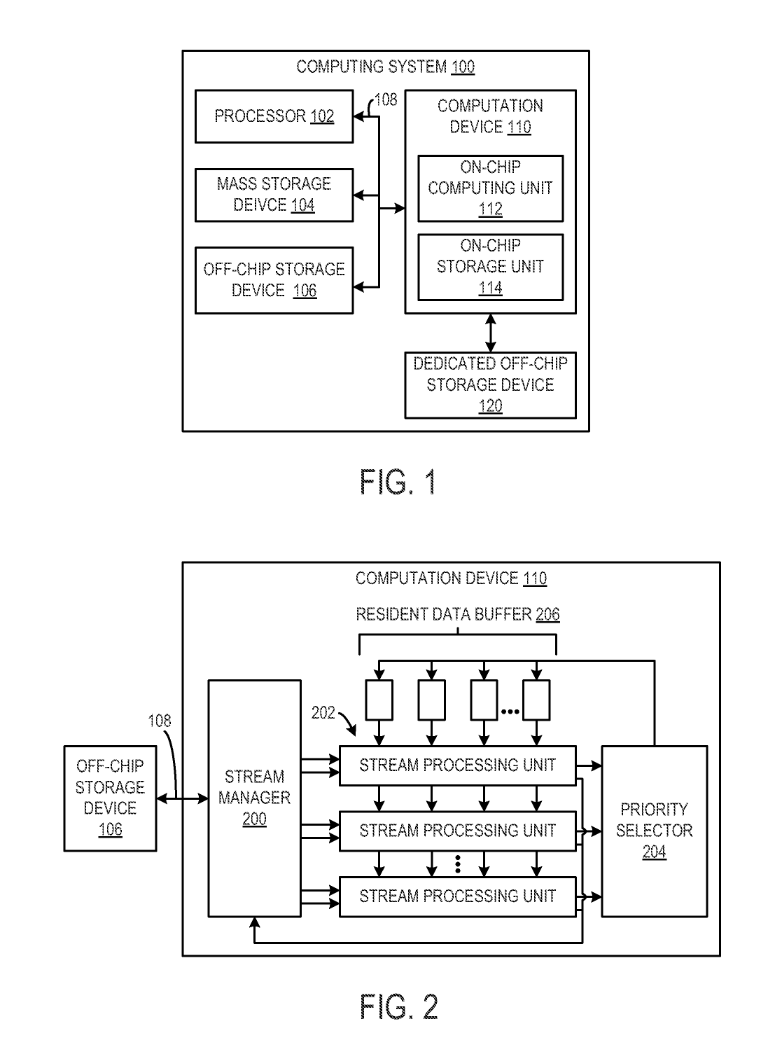

FIG. 1 schematically shows an embodiment of a computing system 100. The computing system 100 may take the form of one or more personal computers, server computers, tablet computers, home-entertainment computers, network computing devices, gaming devices, mobile computing devices (e.g., tablet), mobile communication devices (e.g., smart phone), and/or other computing devices. The computing system 100 may include a processor 102 in communication with a mass storage device 104 and an off-chip storage device 106 via a communications interface 108.

The processor 102 may include one or more processor cores, and instructions executed thereon may be configured for sequential, parallel, and/or distributed processing. Individual components of the processor optionally may be distributed among two or more separate devices, which may be remotely located and/or configured for coordinated processing. Aspects of the processor may be virtualized and executed by remotely accessible, networked computing devices configured in a cloud-computing configuration.

The processor 102 may include one or more physical devices configured to execute instructions. For example, the processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The mass storage device 104 may include one or more physical devices configured to hold instructions executable by the processor 102. When such instructions are implemented, the state of the mass storage device 104 may be transformed—e.g., to hold different data. The mass storage device 104 may include removable and/or built-in devices. The mass storage device 104 may include optical memory, semiconductor memory, and/or magnetic memory, among others. The mass storage device 104 may include volatile, nonvolatile, dynamic, static, read/write, read-only, random-access, sequential-access, location-addressable, file-addressable, and/or content-addressable devices.

Instructions stored in the mass storage device 104 may be executed by the processor 102 using portions of the off-chip storage device 106. The off-chip storage device 106 may include one or more physical devices configured to hold data utilized to carry out execution of the instructions, and store a result when applicable. For example, the off-chip storage device may include one or more volatile memory devices. In one particular example, the off-chip storage device 104 includes dynamic random-access memory (DRAM). It will be understood that the off-chip storage device may include any suitable type of storage device without departing from the scope of the present description.

In one example, instructions may be executed as part of a software program that may utilize various computations as part of execution. As such, the computing system 100 may include a specialized computation device 110 configured to perform specific computations in a very fast and efficient manner. The computation device 110 may be implemented in dedicated hardware as a logic circuit distinct from the processor 102, and linked to the processor 102 by the communications interface 108. For example, the processor 102 may execute an instruction that invokes the computation device 110 to perform computations specified by the instruction. The computation device 110 may be configured to receive the instruction to perform the computations from the software program, retrieve data elements from the off-chip storage device 106 to carry out the computations, process the computations, and return results of the computation to the off-chip storage device. Such a routine may be carried out repeatedly or continuously throughout execution of the software program, such that data may be streamed from the off-chip storage device to the computation device.

The hardware in which the computation device 110 is implemented may be an integrated circuit such as a programmable logic device (PLD) or application specific integrated circuit (ASIC). A field programmable gate array (FPGA) and a complex programmable logic device (CPLD) are two examples of suitable PLDs that may be used to implement the computation device 110. The computation device 110 may be logically separated from the processor 102 and may include an on-chip computing unit 112. Further, the computation device 110 may include the on-chip storage unit 114 formed separate from the off-chip storage device 106. Note that, in some instances, ‘on-chip’ means that the component is physically integrated with the computation device, and ‘off-chip’ means that the component is physically distinct from the computation device.

In some embodiments, the computation device 110 may be implemented as a system-on-chip (“SoC”). In a SoC implementation, typically the processor 102, the off-chip storage device 106, and the computation device 110, are formed as separate logic units within a single SoC integrated circuit, and the communications interface 108 includes an on-chip communications interface subsystem to enable communication between these separate logic units. In some embodiments, the processor 102 and the computation device 110 may be physically integrated in the same chip. Further, the off-chip storage may or may not be integrated in that chip. In some embodiments, the computation device 110 may be in communication with a dedicated off-chip storage device 120 that is physically separate from the off-chip storage device 106. In some embodiments, the dedicated off-chip storage device 120 may only be accessible by the computation device 110. In one example, the off-chip storage device 120 includes DRAM dedicated to the computation device 110. In other embodiments, the off-chip storage device 106 and the dedicated off-chip storage device 120 may be the same device.

Communications interface 108 refers generally to one or more communications subsystems provided to enable communications among the various components of the computing system 100. The communications interface 108 may include one or more discrete I/O paths, each potentially utilizing separate protocols, encodings, and/or physical interfaces. In particular, the communications interface 108 may be configured to provide high-bandwidth communication between the off-chip storage device 106 and the computation device 110, such that data elements may be continuously streamed in multiple data streams from the off-chip storage device to the computation device to perform computations. In one particular example, the communications interface provides up to 32 separate data streams between the off-chip storage device 106 and the computation device 110. It will be understood that the communications interface may provide any suitable number of data streams between the off-chip storage device and the computation device without departing from the scope of the present description.

In one example, the computation device 110 may be configured to perform computations in the form of sparse matrix-vector multiplication. In particular, a sparse matrix-vector multiplication computation may include multiplying each row of a sparse matrix by a vector. The sparse matrix may be stored in the off-chip storage device 106. Each value of the sparse matrix may be associated with a tag that may be used to match that sparse matrix value with an appropriate vector value to perform the sparse matrix multiplication. For example, a tag may indicate a row, a position in a row, and an address of a corresponding vector. The rows of the sparse matrix and the associated tags may be streamed from the off-chip storage device 106 to the computation device 110 according to the bandwidth capability of the communications interface 108. For example, each row of the sparse matrix may be sent as a different data stream. In one particular example, the communications interface 108 may be capable of streaming up to 32 sparse matrix rows in parallel.

Furthermore, the vector may be stored in the on-chip storage device 114 of the computation device 110. The addressing scheme of the vector buffer and the sparse structure of the vector may be fixed and known in advance of the computation. This allows the tag of each stream element to identify an appropriate matching resident element of the vector. The storage device and manipulation of resident elements of the vector will be discussed in further detail below with reference to FIG. 2.

Note that because the row values of the sparse matrix are stored in the off-chip storage device and streamed to the computation device, those values are referred to herein as stream elements. Correspondingly, because the vector values are stored in the on-chip storage device, those values are referred to herein as resident elements. Note that although the resident elements are stored in the on-chip storage device during processing of the sparse matrix, it will be understood that the resident elements may be occasionally brought from the off-chip storage device or the mass storage device to the on-chip storage device. For example, values of a first vector may be replaced as resident elements with values from a second different vector when operation switches to performing computations involving the second vector.

To parallelize the sparse matrix-vector multiplication computation, multiple rows of stream elements of the sparse matrix may be multiplied by the resident elements of the vector in parallel. In particular, selected resident elements of the vector may be opportunistically copied to positional buffers of different parallel processing units based on tags associated with corresponding stream elements. Accordingly, all vector elements selected for the computations may be made available to the different parallel processing units in the same clock cycle without having to copy all of the resident elements of the vector to each parallel processing unit.

FIG. 2 schematically shows the computation device 110 of the computing system 100 in more detail. The computation device 110 includes a stream manager 200, a plurality of stream parallel processing units 202, a priority selector 204, and a resident element data buffer 206.

The stream manager 200 may be configured to read a plurality of data streams in parallel from the off-chip storage device 106 via the communications interface 108. The stream manager may be configured to parse each data stream into stream elements and corresponding tags. For example, each data stream may be associated with a different parallel processing unit, and the stream manager may be configured to send the stream elements and tags of each data stream to that parallel processing unit. In the example where the computation device is configured to perform a sparse matrix-vector multiplication computation, each data stream may include a different row of the sparse matrix and each stream element in that data stream may be a value in that row. In other words, stream elements of the same row in the sparse matrix and their respective tags may be all streamed to the same parallel processing unit, but a single parallel processing unit may (and typically will) process more than one row of the sparse matrix.

Each of the plurality of parallel processing units 202 may be configured to receive the stream elements and associated tags from the stream manager 200. Further, each of the plurality of parallel processing units 202 may send a request to the priority selector 204 for a resident element to be matched with a stream element for a computation in an upcoming clock cycle. The request may include the tag identifying the resident element. Each of the plurality of parallel processing units may include a positional buffer or array that may be configured to store a plurality of selected resident elements that may be used for computations performed over a series of clock cycles. The array may be smaller than the resident element data buffer. In this example, each parallel processing unit is individually responsible for sending requests for resident elements to the priority selector. However, it will be understood that requests may be generated in any suitable manner without departing from the scope of the present description. For example, a global scheduler may be implemented to look at the tags in all of the data streams and make request decisions simultaneously for all of the data streams.

The resident element data buffer 206 may be a multi-banked buffer that stores each resident element (e.g., value) in an individually addressable storage device location. Accordingly, multiple resident elements can be addressed independently on the same clock cycle and driven to a desired location. In the example where the computation device is configured to perform a sparse matrix-vector multiplication computation, each value of the vector may be stored at a different addressable location of the resident element data buffer.

The priority selector 204 may be configured to receive requests for resident elements from each of the plurality of parallel processing units 202. The priority selector may be configured to decide which resident elements to read out of the resident element data buffer based on the requests. In particular, the priority selector outputs addresses of selected banks of the resident element data buffer to drive the values stored at those addresses to the plurality of stream processing units. Ideally, all banks of the resident element data buffer output an element each clock cycle. However, in some cases, one or more banks may not output a resident element, because there may be no tags that identify those banks in any of the requests from the plurality of parallel processing units. Furthermore, the priority selector sends tags that indicate the requested resident elements back to the parallel processing units to coordinate processing of the selected resident elements.

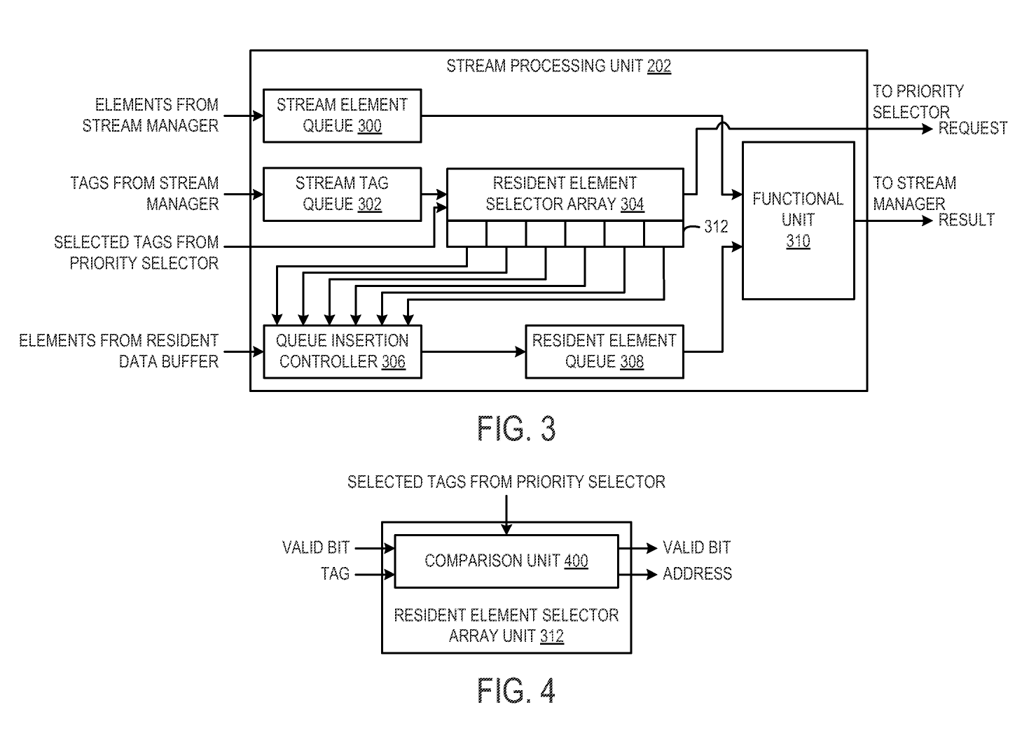

Once the selected resident elements are driven from the resident element data buffer each of the parallel processing units may store one or more corresponding selected resident elements in that parallel processing unit. In other words, each parallel processing unit may be capable of taking in more than one resident element driven out of the resident element data buffer in a clock cycle. The number of resident elements taken in by a parallel processing unit may be based on a number of selector units in a resident element selector unit array of that parallel processing unit that indicate a match with the resident elements as will be discussed in further detail below with reference to FIGS. 3-4.

Furthermore, the parallel processing unit may match the one or more resident elements with one or more corresponding stream elements to perform one or more computations. In the case of multiple matches, the multiple computations may be performed over several clock cycles. The result of the one or more computations may be sent from the stream processing unit to the stream manager (or another unit of the computation device), and the stream manager may send the result to the off-chip storage device to be used as part of execution of the software program by the processor of the computing system. In some cases, the result of the computation can also be used locally to perform another computation that may or may not be part of a sparse matrix-vector multiplication. For example, the result may be used in an addition operation for all multiplication results in a row of the sparse matrix.

In this example, each parallel processing unit is individually responsible for matching a stream element with a resident element to perform a computation. However, it will be understood that a stream element may be matched with a resident element in any suitable manner without departing from the scope of the present description. For example, a global scheduler may be responsible for matching and selecting resident elements for parallel processing units, and individual processing units may only be responsible for following storage and computation instructions received from the global scheduler.

It will be understood that each parallel processing unit may have capacity to store more than one (streaming element, resident element) pair at a time in as will be discussed in further detail below with reference to FIG. 3.

FIG. 3 schematically shows one of the plurality of parallel processing units 202 in more detail. The illustrated parallel processing unit may be representative of all of the parallel processing units. The parallel processing unit may include a stream element queue 300, a stream tag queue 302, a resident element selector array 304, a queue insertion controller 306, a resident element queue 308, and a functional unit 310.

The stream element queue 300 may be configured to receive stream elements from the stream manager 200 shown in FIG. 2. The stream element queue 300 may be configured to store stream elements for later processing of computations by the functional unit 310. As such, the stream element queue may output stream elements to the functional unit.

The stream tag queue 302 may be configured to receive tags from the stream manager 200 shown in FIG. 2. The stream tag queue 302 may be configured to store tags for later processing of stream and resident elements in computations performed by the functional unit 310. In particular, the tags may be loaded into the stream tag queue in the same order that the stream elements are loaded into the stream element queue, so that the stream elements may be processed in the correct order based on analysis of the corresponding tags. The stream tag queue may output the tags to the resident element selector array 304.

The resident element selector array 304 may include a plurality of resident element selector units (a.k.a., selectors) 312. The resident element selector array 304 may be configured to receive tags from the stream tag queue, as well as addresses of selected resident elements indicated from tags received by the priority selector 204 shown in FIG. 2. In particular, each tag and corresponding addresses/tags coming from the priority selector 204 may be sent to each resident element selector unit in an array of each of the plurality of parallel processing units.

FIG. 4 schematically shows one of the plurality of resident element selector units 312 in more detail. The illustrated resident element selector unit may be representative of all of the plurality of resident element selector units in the array. The resident element selector unit may include a comparison unit 400. The comparison unit may be configured to receive a valid bit and a tag from the stream tag queue. The valid bit indicates whether the tag from the stream tag queue is valid. Further, the comparison unit may be configured to receive addresses of resident elements selected by the priority selector to be driven from the resident element data buffer. The comparison unit may be configured to compare an address on the tag from the tag queue with the addresses received from the priority selector to determine if there is a match. If there is a match, then the comparison unit outputs the address of the matching resident element, along with a valid bit indicating that the match is valid (e.g., 1). If there is not a match, then the comparison unit outputs the valid bit indicating that the match is not valid (e.g., 0). The valid bit indicates whether the resident element corresponding to the address on the tag for that selector unit will be eventually used in a computation by the parallel processing unit. The output of each resident element selector unit may be sent to the queue insertion controller 306.

The queue insertion controller 306 may be configured to receive resident elements from the resident element data buffer, and insert matching resident elements selected by the selectors units of the resident element selector array 304 into the resident element queue 308. For example, every bank of the resident element data buffer may be connected to the queue insertion controller and the parallel processing unit may choose which resident elements to copy from the selected resident elements driven from the resident element data buffer. For example, because there are ‘n’ selector units in the resident element selector array, there could be ‘n’ such selected resident elements in a clock cycle, so one or more selected resident elements up to ‘n’ resident elements may be inserted in the resident element queue based on the number of valid bits outputted from the selector units of the resident element selector array.

The resident element queue 308 may be configured to store selected resident elements inserted by the queue insertion controller 306 for later processing of computations by the functional unit 310. Each resident element in the resident element queue corresponds to the stream element in the stream element queue that provided the tag to select the resident element. The corresponding stream element and resident element are stored at the same queue depth in their respective queues. As such, the resident element queue may output resident elements to the functional unit.

The resident element queue 308 may be configured to receive a variable number of resident elements per cycle. In particular, the number of resident element may vary based on a number of matches produced by the resident element selector array for a given cycle. The resident element queue may be distinguished from a typical queue that receives either a fixed number of elements per cycle or zero elements per cycle.

The functional unit 310 may be configured to perform a specified or arbitrary computation between a stream element received from the stream element queue and a resident element received from the resident element queue. For example, the computation may be part of a multiplication operation. In a particular example, the computation may include a multiplication of a sparse matrix row and a vector. Specifically, by queuing the non-zero stream elements from the row of the sparse matrix and the resident elements of the vector such that they are aligned, the appropriate elements may be multiplied by the functional unit. Further, the functional unit may be configured to accumulate the results of each multiplication to process the entire row.

It will be understood that the computation may include any suitable computation or other operation without departing the scope of the present description. Moreover, sets of computations or operations may be contemplated. Further, the result of the computation may be sent to the stream manager and further to the off-chip storage device. Additionally or alternatively, the result may be sent to other system components. For example, the result may be written back into the resident element data buffer or another location of the on-chip storage device to be used for another computation. Although the computation device has been discussed in the context of training and evaluating deep neural networks, it will be understood that the computation device may be employed for any suitable processing operations without departing from the scope of the present disclosure.

It will be understood that the queues implemented in the parallel processing unit may operate according to first-in-first-out principles (FIFO). However, other principles of operation may be contemplated. Furthermore, the queues are merely one example of a type of data structure that may be employed to store information in the parallel processing units, and other data structures may be employed without departing from the scope of the present description.

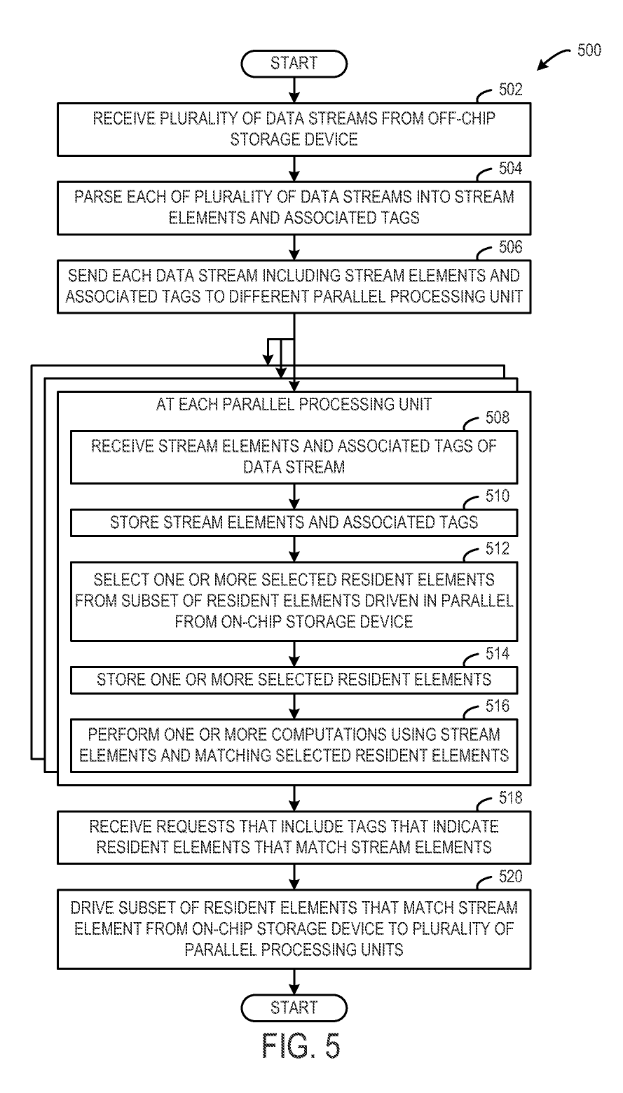

FIG. 5 shows a method 500 for performing computations with a plurality of parallel processing units of a computation device according to an embodiment of the present disclosure. For example, the method may be carried out by the computation device 110 of the computing system 100 shown in FIG. 1. Furthermore, it will be understood that different logic components of the computation device may carry out different portions of the method 500.

At 502, the method 500 may include receiving, at a computation device, a plurality of parallel data streams from an off-chip storage device. For example, the data streams may be sent via the high-bandwidth communications interface 108 shown in FIG. 1.

At 504, the method 500 may include parsing each of the plurality of parallel data streams into stream elements and associated tags. For example, parsing may be performed by the stream manager 200 shown in FIG. 2.

At 506, the method 500 may include sending each data stream including the stream elements and associated tags to a different parallel processing unit. For example, the stream manager 200 may send each data stream including the stream elements and associated tags to a different one of the plurality of parallel processing units 202. In other words, in this example, there is a 1:1 mapping between a data stream and a parallel processing unit that processes that data stream, such that all stream elements in a data stream are processed by the same parallel processing unit. However, in some embodiments, two or more parallel processing units may cooperate to process a single data stream, and more particularly a row of a sparse matrix without departing from the scope of the present description.

At 508, the method 500 may include, at each parallel processing unit, receiving stream elements and associated tags of a data stream. For example, the stream elements and associated tags of the data stream may be received from the off-chip storage device 106 via the stream manager 200.

At 510, the method 500 may include, at each parallel processing unit, storing the stream elements and the associated tags. For example, the stream elements may be stored in the stream element queue 300 and the associated tags may be stored in the stream tag queue 302.

At 512, the method 500 may include, at each parallel processing unit, selecting one or more selected resident elements from a subset of resident elements driven from the on-chip storage device 114, and more particularly the resident element data buffer 206. The one or more selected resident elements may be indicated by the associated tags as matching one or more of the stream elements and may be selected because of this indication.

At 514, the method 500 may include, at each parallel processing unit, storing the one or more selected resident elements of the subset of resident elements. For example, the one or more selected resident elements may be stored in the resident element queue 308.

At 516, the method 500 may include, at each parallel processing unit, performing one or more computations using stream elements and matching selected resident elements. For example, the computation may be part of a sparse matrix-vector multiplication for a row of a sparse matrix. The stream elements may include sparse matrix row values of a row being processed by that parallel processing unit. The plurality of resident elements may include values of a vector to be multiplied with each row of the sparse matrix as part of the sparse matrix-vector multiplication computation. In one particular example, a parallel processing unit receives and processes all row values of a given row of the sparse matrix. Further, a given parallel processing unit may process multiple rows of the sparse matrix.

At 518, the method 500 may include receiving requests from the plurality of parallel processing units. The requests may include tags that indicate resident elements that match stream elements received by the plurality of parallel processing units. For example, the requests may be sent from the plurality of processing units 202 to the priority selector 204 shown in FIG. 2. The priority selector 204 may aggregate the requests of the plurality of parallel processing units and control the resident data buffer based on the requests, and more particularly the tags that indicate the resident elements that match the stream elements.

At 520, the method 500 may include driving the subset of resident elements that match the stream elements from the on-chip storage device to the plurality of parallel processing units in parallel. For example, the priority selector 204 may drive the independently addressable banks of the resident data buffer 206 that correspond to the subset of resident elements to send those resident elements to the plurality of parallel processing units.

It will be understood that when the subset of resident elements are driven from the resident element data buffer, different parallel processing units may select one or more resident elements of the subset to store in a resident element queue of that parallel processing unit based on evaluations of tags by resident element selector units in that parallel processing unit.

Further, it will be understood that the requests received at 518 of the method 500 that cause the subset of resident elements to be driven from the resident element data buffer at 520 of the method 500 may be consumed during subsequent clock cycles by the parallel processing units at 512-516 of the method 500. Likewise, the resident elements selected at 512 of the method 500 may be based on requests made during previous clock cycles.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system comprising:
an off-chip storage device configured to store a plurality of stream elements and associated tags; and
a computation device in communication with the off-chip storage device, the computation device including:
an on-chip storage device configured to store a plurality of independently addressable resident elements; and
a plurality of parallel processing units, each parallel processing unit being configured to:
receive one or more stream elements and associated tags from the off-chip storage device;
select one or more resident elements from a subset of resident elements driven in parallel from the on-chip storage device, wherein a selected resident element is indicated by an associated tag as matching a stream element; and
perform one or more computations using the one or more stream elements and the one or more selected resident elements.

2. The computing system of claim 1, wherein multiple parallel processing units of the plurality of parallel processing units select a same resident element from the subset of resident elements in a same clock cycle.

3. The computing system of claim 1, wherein the computation device further includes a stream manager configured to receive a plurality of parallel data streams from the off-chip storage device, parse each of the plurality of parallel data streams into stream elements and associated tags, and send the stream elements and associated tags of each data stream to a different parallel processing unit, wherein all stream elements and associated tags of a data stream are processed by a single parallel processing unit.

4. The computing system of claim 1, wherein the computation device further includes a priority selector configured to receive requests from the plurality of parallel processing units, the requests including tags that indicate resident elements that match stream elements received by the plurality of parallel processing units, and drive the subset of resident elements that match the stream elements from the on-chip storage device to the plurality of parallel processing units.

5. The computing system of claim 1, wherein the on-chip storage device includes a resident element data buffer configured to store the plurality of resident elements in independently addressable banks.

6. The computing system of claim 1, wherein each parallel processing unit includes:
a stream element queue configured to store the one or more stream elements;
a stream tag queue configured to store the associated tags;
a resident element selector array including a plurality of resident element selector units, each resident element selector unit configured to compare addresses of the subset of resident elements selected by a priority selector to the address of a requested resident element indicated by an associated tag and if the requested resident element matches one of the resident elements of the subset, output an indication of the match;
a queue insertion controller configured to insert the one or more selected resident elements in a resident element queue based on receiving an indication of a match from the resident element selector array; and
a functional unit configured to receive a stream element from the stream element queue and a selected resident element from the resident element queue that matches the stream element, and perform a computation using the stream element and the selected resident element.

7. The computing system of claim 1, wherein the off-chip storage device includes dynamic random-access memory.

8. The computing system of claim 1, wherein the computation device is one of a field programmable gate array (FPGA), an application specific integrated circuit (ASIC), or a system-on-chip (SoC).

9. The computing system of claim 1, wherein the plurality of stream elements include values of a sparse matrix, wherein each parallel processing unit receives values of a different row of the sparse matrix, the plurality of resident elements includes values of a vector to be multiplied with each row of the sparse matrix, and wherein the computations are part of a sparse matrix-vector multiplication for a row of the sparse matrix.

10. A computing system comprising:
an off-chip storage device configured to store a plurality of stream elements and associated tags; and
a computation device in communication with the off-chip storage device, the computation device including:
an on-chip storage device configured to store a plurality of independently addressable resident elements;
a stream manager configured to:
receive a plurality of parallel data streams from the off-chip storage device;
parse each of the plurality of parallel data streams into stream elements and associated tags; and
send the stream elements and associated tags of each data stream to a different parallel processing unit of a plurality of parallel processing units, wherein all stream elements of a data stream are processed by a single parallel processing unit; and
each parallel processing unit of the plurality of parallel processing units being configured to:
receive stream elements and associated tags of a data stream from the stream manager;
send requests to a priority selector for selected resident elements indicated by the associated tags, wherein the priority selector is configured to aggregate requests received from the plurality of parallel processing units to form a subset of resident elements and drive the subset of resident elements from the on-chip storage device to each of the plurality of parallel processing units;
select the resident elements from the subset of resident elements driven from the on-chip storage device; and
perform computations using the stream elements and the selected resident elements.

11. The computing system of claim 10, wherein multiple parallel processing units of the plurality of parallel processing units select a same resident element from the subset of resident elements in a same clock cycle.

12. The computing system of claim 10, wherein the on-chip storage device includes a resident element data buffer configured to store the plurality of resident elements in independently addressable banks.

13. The computing system of claim 10, wherein each parallel processing unit includes:
a stream element queue configured to store the one or more stream elements;
a stream tag queue configured to store the associated tags;
a resident element selector array including a plurality of resident element selector units, each resident element selector unit configured to compare addresses of the subset of resident elements selected by a priority selector to the address of a requested resident element indicated by an associated tag and if the requested resident element matches one of the resident elements of the subset, output an indication of the match;
a queue insertion controller configured to insert the one or more selected resident elements in a resident element queue based on receiving indications of matches from the resident element selector array; and
a functional unit configured to receive a stream element from the stream element queue and a selected resident element from the resident element queue that matches the stream element, and perform a computation using the stream element and the selected resident element.

14. The computing system of claim 10, wherein the off-chip storage device includes dynamic random-access memory.

15. The computing system of claim 10, wherein the computation device is one of a field programmable gate array (FPGA), an application specific integrated circuit (ASIC), or a system-on-chip (SoC).

16. The computing system of claim 10, wherein the plurality of stream elements include values of a sparse matrix, wherein each parallel processing unit receives values of a different row of the sparse matrix and processes all row values for that row, the plurality of resident elements includes values of a vector to be multiplied with each row of the sparse matrix, and wherein the computations are part of a sparse matrix-vector multiplication for a row of the sparse matrix.

17. A method for performing computations with a plurality of parallel processing units of a computation device, the method comprising:
at each parallel processing unit, receiving one or more stream elements and associated tags from an off-chip storage device;
selecting one or more resident elements from a subset of independently addressable resident elements driven in parallel from an on-chip storage device, wherein a selected resident element is indicated by an associated tag as matching a stream element; and
performing one or more computations using the one or more stream elements and the one or more selected resident elements.

18. The method of claim 17, further comprising:
receiving, at the computation device, a plurality of parallel data streams from the off-chip storage device;
parsing each of the plurality of parallel data streams into stream elements and associated tags; and
sending the stream elements and associated tags of each data stream to a different parallel processing unit, wherein all stream elements and associated tags of a data stream are processed by a single parallel processing unit.

19. The method of claim 17, further comprising:
receiving requests from the plurality of parallel processing units, wherein the requests include tags that indicate resident elements that match stream elements received by the plurality of parallel processing units; and
driving the subset of resident elements that match the stream elements from the on-chip storage device to the plurality of parallel processing units in parallel.

20. The method of claim 17, wherein the computation is a sparse matrix-vector multiplication, wherein the stream element includes a row value of a sparse matrix, wherein each parallel processing unit receives values of a different row of the sparse matrix, and wherein the selected resident element includes a value of a vector to be multiplied with the row value as part of the sparse matrix-vector multiplication.
